(19) United States
(12) Patent Application Publication
(10) Pub. No.: US 2008/0004892 A1
(43) Pub. Date: Jan. 3, 2008

(54) BIOMETRIC AID FOR CUSTOMER RELATIONS

(76) Inventor: Jerry Zucker, Charleston, SC (US)

Correspondence Address: HAMMER & HANF, PC, 3125 SPRINGBANK LANE, SUITE G, CHARLOTTE, NC, 28226, US

(21) Appl. No.: 11/771,090

(22) Filed: Jun. 29, 2007

Related U.S. Application Data
(60) Provisional application No. 60/817,873, filed on Jun. 30, 2006.

(51) Int. Cl. G06Q 10/00; G06Q 30/00

(52) U.S. Cl. 705/1

(57) ABSTRACT

A system for welcoming a customer to a retail outlet to be used by a greeter comprising a customer recognition system (CRS) operatively associated with the greeter. When a customer is recognized by the CRS, the CRS sends a message to the greeter comprising information about the customer. The greeter may then welcome the customer with a personalized greeting.

### RELATED APPLICATION

This application claims the benefit of co-pending provisional application Ser. No. 60/817,873 filed Jun. 30, 2006.

### FIELD OF THE INVENTION

The present invention relates to the use of biometric identifiers to aid and enhance customer relations in a retail setting.

### BACKGROUND OF THE INVENTION

Retail outlets are always seeking out methods to improve their relationships with customers. In the past, customers frequented small, specialized stores in order to purchase life's necessities. Store owners were able to develop relationships with repeat customers. Store owners and employees often knew customers by name, knew extended families, and knew about past special events and those occurring in the future. However, “Mom and Pop” stores with their cozy, personal atmosphere are fading into history to only to be replaced with larger retail outlets, such as department stores. It is more difficult for personal relationships to develop within the larger retail outlets where the business model seeks to maximize profits and focuses less on befriending customers. Additionally, the transient nature of today's population makes it more difficult to maintain retail outlet/customer relationships.

Retail outlets seeking to improve customer relations may employ a variety of methods to foster the development of relationships with repeat customers. Some retail outlets station a greeter near the entrance to welcome each customer with a friendly “Hello”. However, there is an unsatisfied need for a system which allows a retail outlet to improve customer relations.

Currently biometric systems exist that can identify the presence of designated individuals within video field based on their facial biometrics. Biometric systems are currently utilized for security purposes to either verify that an individual should be where they are, that an individual is who they claim to be, or to identify targeted suspects (e.g., card counters in a casino). These systems use a biometric system, which use an establishment's security system along with a photo of the designated individuals. When the image of one of the designated individuals shows up in the video field of view, the establishment's security can be alerted to their presence, so that they can be escorted off the property. Face recognition systems are particularly attractive as they are normally unobtrusive and are passive (i.e., they do not require electromagnetic illumination of the subject of interest). A number of face recognition systems are currently available (e.g., products are offered by Visionics, Viisage and Miros).

Examples of this type of system comes from the companies Viisage and Identix (now merged to form L-1 Identity Solutions). (Currently, Identix is installing a pilot system of 5 cameras at Hbc Store at 401 Pray Street, Toronto. Viisage's biometric solutions for casinos and the leisure industry provide effective identification tools for use in surveillance, ticketing and overall area security. Consequently, a casino or leisure park can protect its assets better, without disturbing the atmosphere for players and visitors. Viisage's systems are proven and cost effective, and help organizations reduce losses from theft and improve overall security. The solutions are built on existing security & surveillance infrastructures and help implement better visitor management by making identity information readily accessible.

U.S. Pat. No. 6,698,653 discloses a facial identification method which may be used for personal identification of individuals in an airport setting. A camera at an airport check-in location acquires an image of an individuals face, digitizes the image, stores the image in a database, and records the digital image on a single-use disposable chip carried by the individual. The camera may be contained within the ticket dispenser. At another location, such as the boarding gate, the image stored on the chip and the image stored in the database are compared to verify the individual's identity. An image obtained from the above mentioned ticket-dispenser camera may be compared to the facial biometric data stored on the individual's credit card, or compared to stored facial biometric data in a local, regional or national database. In an airport setting, law enforcement organizations may employ facial recognition software to monitor incoming images and confirm positive matches with known terrorists. However, the above system is designed to improve security in a public transportation setting, not improve customer relations in a retail outlet setting.

U.S. Pat. No. 5,561,718 discloses a face classification system wherein an image is captured, a face is located within the captured image, a feature vector is produced from the face and compared with previously captured feature vectors for potential matches. Captured feature vectors may be stored in a database. The system can be used as a means to prevent credit card fraud by encoding a feature vector of the authorized user onto the card's memory and comparing that vector with a vector acquired during the transaction. An image of the credit card user may be acquired by a video camera transmitted from a transaction terminal. An authorization or alarm signal may be sent to the transaction terminal to either provide or withhold authorization for use of the card. However, the above system is designed to prevent credit card fraud, not improve customer relations in a retail outlet setting.

U.S. Patent Application No. 2006/0087439 discloses a system for screening personnel at secured installations through the use of a biometrics parameter scanner to acquire biometric-identifiers such as retinal or iris scanning, finger prints, or face recognition. Installations may use a database that includes personnel information of security risks for identification of individuals. At least one personal identity document must be scanned and stored along with the captured biometric in a database. Security may be alerted when an individual's identity is confirmed in the database and any detrimental information is discovered. Security scanning facilities may be linked to law enforcement agency's database, which upon finding a match of an undesirable, may alert law enforcement personnel. However, the above system is designed to improve security in both public and private secure installations, not improve customer relations in a retail outlet setting.

U.S. Patent Application No. 2005/0063566 discloses a method of recording and confirming the identity of faces that are automatically obtained in security areas where the movement of people cannot be constrained within defined boundaries. Images are obtained using a camera and a face imaging system that is capable of tracking multiple target faces within a security area and providing high quality images of those faces for recording and/or for use in face recognition systems for purposes of face verification, face recognition and face comparison. Face images are captured and recorded and made available to face recognition software for biometric verification and identification and comparison to external databases. Face recognition software may be used to compare a captured face image to a face image taken from another instrument such as a passport. However, the above system is designed to improve security in both public and private unsecured installations, not improve customer relations in a retail outlet setting.

Hence, there exists an unsatisfied need for a system which allows a retail outlet to improve customer relations.

### SUMMARY OF THE INVENTION

A system for welcoming a customer to a retail outlet to be used by a greeter comprising a customer recognition system (CRS) operatively associated with the greeter. When a customer is recognized by the CRS, the CRS sends a message to the greeter comprising information about the customer. The greeter may then welcome the customer with a personalized greeting.

### BRIEF DESCRIPTION OF THE DRAWINGS

For the purpose of illustrating the invention, there is shown in the figures a form that is presently preferred; it being understood, however, that this invention is not limited to the precise arrangements and instrumentalities shown.

FIG. 1 illustrates an embodiment of a customer being imaged at a checkout counter and the customer recognition system (CRS).

FIG. 2 illustrates an embodiment of a customer being imaged upon entering a retail outlet.

FIG. 3 illustrates an embodiment the customer recognition system (CRS).

FIG. 4 illustrates an embodiment of the cross hair camera view.

FIG. 5 illustrates an embodiment of the laser pointer camera view.

### DETAILED DESCRIPTION OF THE INVENTION

The present invention provides a biometric aid for customer relations. Biometrics are automated methods of recognizing a person based on physiological or behavioral characteristics. Among the features measured are face, fingerprints, hand geometry, handwriting, iris, retinal, vein, and voice. A biometric system is essentially a pattern recognition system which recognizes a user by determining the authenticity of a specific physiological or behavioral characteristic possessed by the user. Several important issues must be considered in designing a practical biometric system. First, a user must be enrolled in the system so that his biometric template can be captured. This template is securely stored in a central database or a smart card issued to the user. The template is retrieved when an individual needs to be identified. Depending on the context, a biometric system can operate either in a verification (authentication) or an identification mode.

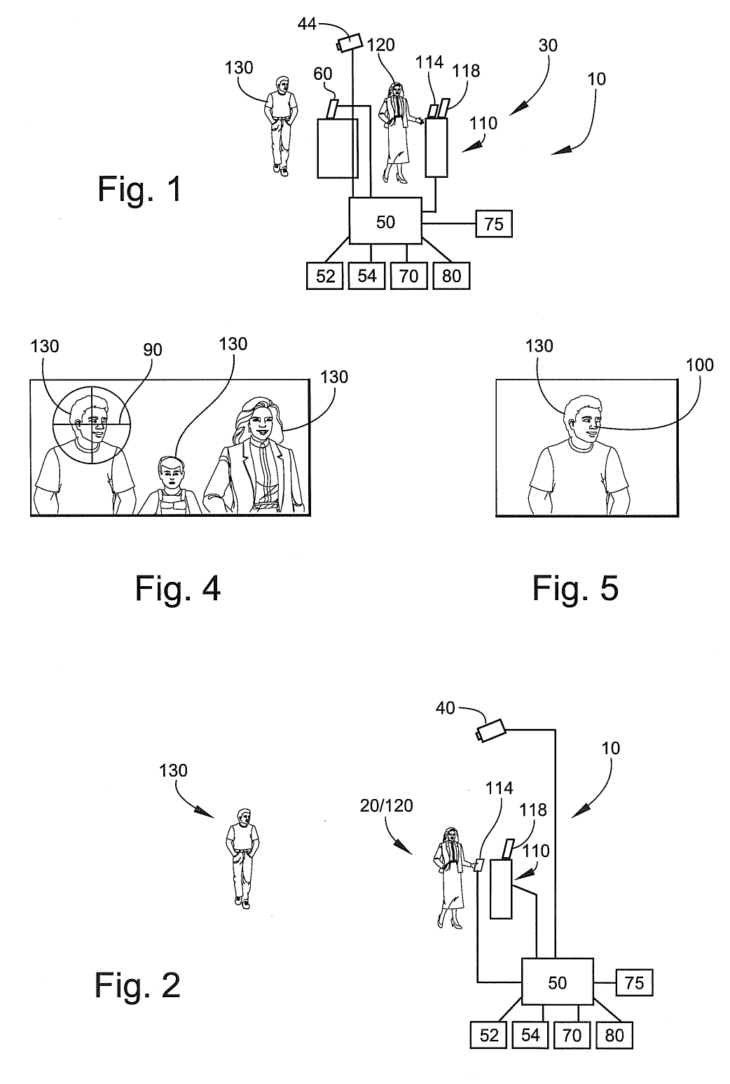

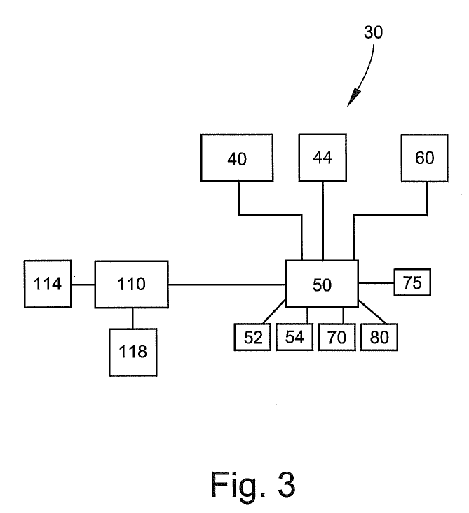

Referring to the drawings, wherein like numerals indicate like elements, there is shown in FIGS. 1 and 2 an embodiment of a system 10 for welcoming a customer to a retail outlet. The system 10 may be used by a greeter 20 or a clerk 120 and is comprised of a customer recognition system 30. The customer recognition system 30, FIG. 3, is comprised of a central processing unit (CPU) 50, a database 52 operatively associated with the CPU 50, a camera 40 operatively associated with the CPU 50, and a biometric face recognition program 70 operatively associated with the CPU 50. In one embodiment, the camera is a camera at a checkout counter 44. In another embodiment, a credit/debit card reader 60 is operatively associated with the CPU 50 and the camera 40. In yet another embodiment, the camera 40 is set up to take an image of a customer 130 and associate that image with information obtained by the credit/debit card reader 60 to store in the database 52 as a customer image and information. In yet another embodiment, the camera is a camera at a checkout counter 44 which is set up to take a first image of a customer 130 and associate that first image with information obtained by the credit/debit card reader 60 to store in the database 52.

The system 10 for welcoming a customer to a retail outlet may further comprise a terminal 100 where a greeter 20/clerk 120 can add additional information about a customer 130 to the database 52. In one embodiment, the system 10 may further comprise a program to recognize known undesirables 80 that notifies security of their presence. In another embodiment, the system 10 may further comprise a program to recognize images of individuals authorized to use a credit/debit card 75. If the person using a credit/debit card does not match the image on file in said database 52 and notifies the clerk 120 and/or security. In still another embodiment, the system may further comprise a program to track the shopping habits of a customer 54.

The system 10 for welcoming a customer to a retail outlet and the customer recognition system 30 may further comprise a camera 40 with either: cross hairs 90, FIG. 4; or a laser pointer 100, FIG. 5; to pinpoint the image wanted.

A customer 130, as used herein, refers to an individual who makes use of or receives the products or services of an individual or organization at a retail outlet. In one embodiment, a customer may refer to an individual who has never purchased a product or service and is merely comparing pricing and merchandise in a retail outlet. In another embodiment, a customer may refer to an individual who frequently purchases products and/or services from a retail outlet.

Retail outlet, as used herein, refers to a location where a customer 130 may go to purchase the products or services of an individual, association or organization. A retail outlet may include, but is not limited to, a store, a kiosk, a mall, a tent, a warehouse, a strip mall, a shopping center, or combinations thereof.

A greeter 20 or clerk 120, as used herein, refers to one or more persons who are employees of a retail outlet. A greeter 20/clerk 120 may also occupy another position within the retail outlet such as a cashier, a manager, or a security guard. In one embodiment, a greeter 20 may refer to an employee permanently positioned near the entrance of a retail outlet. In another embodiment, a greeter 20 may refer to an employee who randomly moves within a retail outlet, greeting customers 130 as he/she meets them. In yet another embodiment, a greeter 20 may refer to a computer generated, virtual person or character who welcomes a customer into a retail outlet. In yet another embodiment, a greeter 20 may refer to a computer controlled robot who welcomes customers into a retail outlet.

A customer recognition system (CRS), as used herein, is a system comprised of a central processing unit (CPU) 50, a camera or a plurality of cameras 40, a database 52, and a biometric face recognition program 70. The CRS may be comprised of three basic components. The first component is a sensor that detects the characteristic being used for identification. In one embodiment the sensors are the camera or the plurality of cameras used to obtain an image of the customer. The second component is a computer that processes and/or stores the information obtained from the sensor. In one embodiment the computer is the CPU and database that processes and/or stores the information obtained from the plurality of cameras. The third component is software that analyzes the characteristic, converts the characteristic into a computer readable format and performs the comparison of new characteristic information with characteristic information on file. In one embodiment, the biometric face recognition program is the software that analyzes the information obtained from the camera or plurality of cameras and compares it with information previously saved in the database.

Additionally, the CRS may be comprised of a credit/debit card reader 60. In one embodiment, the credit/debit card reader 60, like the camera 40, is a sensor used to obtain personal information about the customer. The CPU 50 then associates the information obtained by the credit/debit card reader with the image of the customer and processes and/or stores the customer image and information in the database 52. The biometric face recognition program 70 is the software that analyzes the information obtained by the credit/debit card reader 60 and the camera or plurality of cameras 40 and compares it with information previously on the database 52 to determine the identity of the customer 130.

Operatively associated, as used herein, refers to two or more devices working with one another. Devices may be operatively associated mechanically, by wire, or wirelessly.

A central processing unit (CPU) 50, as used herein, interprets computer program instructions and processes data. CPUs provide the fundamental digital computer trait of programmability, and are one of the necessary components found in computers of any era, along with primary storage (e.g., database) and input/output facilities (e.g., camera, terminal). In one embodiment, one or more CPUs may operate within the CRS. In one embodiment the CPU may be operatively associated with the following items including, but not limited to, a database 52, a camera or a plurality of cameras 40, a camera at a checkout counter 44, a credit/debit card machine 60, a terminal 110, an input terminal 114, an output terminal 118, a program to track the shopping habits of a customer 54, a customer recognition program 70, a program to recognize images of individuals authorized to use a credit/debit card 75, a customer recognition program 80, or combinations thereof.

A camera or a plurality of cameras 40, as used herein, refers to one or more cameras, used separately or together to monitor the retail outlet, improve security, prevent theft, and improve customer relations within a retail outlet. The camera or plurality of cameras 40 may be operatively associated with the CPU 50. A camera at a checkout counter 44 refers to a camera which is temporarily or permanently mounted at or near a checkout counter in a retail outlet. In another embodiment, a camera at a checkout counter 44 may be mounted near a credit/debit card reader 60 in a retail outlet. The type of camera may be selected from the group comprising: digital, film, still, video, webcams, or combinations thereof. In one embodiment, a camera may be equipped with cross hairs 90 to enhance the ability of a camera operator to select the individual or customer they wish to image. In another embodiment, a camera may be equipped with a laser pointer 100 to enhance the ability of a camera operator to select the individual or customer they wish to image. In yet another embodiment, the camera 40 may be controlled by a greeter/clerk by using a keyboard, a mouse, a joystick, a touchpad, a touchscreen, a light pen, a stylus, or combinations thereof.

A database 52, as used herein, refers to a device which is operatively associated with the CPU 50. The database 52 may be a collection of information organized in such a way that a computer program can quickly select desired pieces of data. A database 52 may be an electronic filing system comprised of a structured collection of records or data that is stored in a storage device so that a program can consult it to answer queries. The records retrieved in answer to queries become information that can be used to make decisions. Examples of a storage device include, but are not limited to CD, CD-R, CD-RW, DVD, Flash memory, Floppy disk, Zip Drive, Hard disk drive, Magnetic tape, Paper tape, Punch card, RAM disk, External Hard Drive, Blu-Ray, HD-DVD, Thumb Drive, or combinations thereof. In one embodiment, the database 52 may contain images and information about known individuals, including customers 130, obtained from sources including, but not limited to, local government offices, state government offices, national government offices, foreign government offices, affiliated businesses, non-affiliated businesses, in-store cameras, out-of-store cameras, or combinations thereof. In yet another embodiment, the database 52 may contain images and information about known undesirables from each of the sources listed above. In still another embodiment, the database 52 may contain images, information, and data from sources including, but not limited to, a program for recognizing images of individuals authorized to use a debit/credit card 75, a program for recognizing known undesirables 80, a program to track the shopping habits of a customer 54, a biometric face recognition program 70, known customers from the sources listed above, known undesirables obtained from the sources listed above, or combinations thereof.

A credit/debit card reader 60, as used herein, refers to a device which may be operatively associated with the CPU 50. It is a device which has the ability to extract information from an individual's credit/debit card and send that information to the database 52 to be recorded. Information obtained from said credit/debit card reader 60 refers to customer information selected from the group comprising: a first name, a middle name or initial, a last name, an address, a phone number, or combinations thereof. In one embodiment, a credit/debit card reader may be used to extract personal information from the credit/debit card of a customer at a retail outlet. In another embodiment, the information obtained from the credit/debit card of a retail outlet customer may be combined with a digital image of that customer and stored in a database 52. In yet another embodiment, a credit/debit card reader may be used to extract personal information from any type of magnetic stripe card. In yet another embodiment, a credit/debit card reader may be used to extract personal information from an integrated circuit card (i.e., smart card). In still another embodiment, a credit/debit card reader may be used to extract personal information from a computer chip carried by an individual or implanted into an individual.

A first image, as used herein, refers to the first image captured of a customer 130 by a camera 40. In one embodiment, the first image may be captured by the camera at the checkout counter 44. The first image is stored in a database 52 along with personal information about the customer 130 obtained from the credit/debit card reader 60 during a purchase of goods or services at a retail outlet. Software exists to pick the optimum photo, from a group of photos, for subsequent use in enrollment. In this application multiple cameras take shots of an individual and software/program selects the best digital photo to quote ‘enroll’ the biometric data for general use. Present and ongoing future use of an image requires a high quality image. The system rates images on scale of 1-10, with a 10 being the best image. To use an image for ‘enrollment’ one needs an image with an assigned quality of at least 6.5 or better, for the photo to be used in enrollment. This image quality ensures high accuracy for the best results.

A biometric face recognition program 70, is a computer-driven application for automatically identifying a person from a digital image operatively associated with the CPU 50. It does that by comparing selected facial features in the live image and a facial database. It refers to a computer program with the ability to recognize a face in a digital image and then measure the various features of that face and record them. Every face has numerous, distinguishable landmarks, the different peaks and valleys that make up facial features. Each human face has approximately 80 landmarks. The biometric face recognition program 70 may measure and compare landmarks on a customer's face selected from the group comprising: the distance between the eyes, the width of the nose, the depth of the eye sockets, the shape of the cheekbones, the length of the jaw line, or combinations thereof. These landmarks are measured creating a numerical code which represents the face when it is stored in the database 52.

Additional images, as used herein, refer to images of customers obtained by a camera or plurality of cameras 40 operating within and around the retail outlet. These additional images may be sent to the CPU 50 and compared by the biometric face recognition program 70 with previously captured first images and/or other known individuals (e.g., known undesirables 80). In one embodiment, additional images are compared and discarded. In another embodiment, additional images are compared and stored, or vice versa, in the database 52.

A message, as used herein, refers to information sent from the CPU and/or database 52 to the greeter 20 or clerk 120. The message may be comprised of information about a customer which is detailed below. The message will enable the greeter 20 or clerk 120 to greet the customer with a personal greeting. In one embodiment, the message contains information from the database 52. In another embodiment, the message contains information from the customer recognition program 70. In yet another embodiment, the message contains information from the program to recognize undesirables 80. In yet another embodiment, the message contains information from the program to track the shopping habits of customers 54. In still another embodiment, the message may contain information from the program for recognizing images of individuals authorized to use a debit/credit card 75. In still another embodiment, the message may contain information from one or more of the sources listed above.

Information about a customer may refer to information selected from the group comprising: a first name, a middle name or initial, a last name, a nickname, height, weight, hair color, eye color, skin color, ethnicity, an address, a phone number, an occupation, hobbies, relative's names, employer, employees, friends, hometown, vacation plans, upcoming celebrations (graduations, birthdays, anniversaries, etc.), or combinations thereof. A personal greeting, as used herein, refers to a greeting from a greeter 20 or a clerk 120 employed by a retail outlet to a customer 130 which may include any of the information about a customer previously discussed.

A program for recognizing known undesirables 80, as used herein, is a computer-driven application for automatically identifying a person from a digital image which may operate in conjunction with, or separately from a biometric face recognition program (BFRP). The program for recognizing known undesirables 80 is operatively associated with the CPU 50. Known undesirables are individuals who are known for perpetrating or participating in unscrupulous behaviors or activities. Known undesirables include, but are not limited to, persons with criminal records, terrorists, shoplifters, a person banned from a retail outlet, or combinations thereof. If working separately from the BFRP, the program for recognizing known undesirables operates using the same principals and techniques as the BFRP. If the program for recognizing know undesirables 80 identifies a know undesirable, security may be notified to allow security to monitor the known undesirable or escort them from the retail outlet. Retail outlet security, as used herein, refers to any individual employed by a retail outlet to prevent theft, monitor store employees and customers, and to keep known undesirables out of the retail outlet. In one embodiment, the program for recognizing known undesirables is augmented by an additional database containing images and information about known undesirables from any of the sources detailed above.

A program for recognizing images of individuals authorized to use a debit/credit card 75, as used herein, refers to a computer-driven application for automatically identifying a person from an image which may operate in conjunction with, or separately from a biometric face recognition program (BFRP). The program for recognizing images of individuals authorized to use a debit/credit card is operatively associated with the CPU 50. In one embodiment, the program for recognizing images of individuals authorized to use a debit/credit card 75 may be augmented by an additional database containing images and information about individuals authorized to use a debit/credit card.

A program to track the shopping habits of a customer 54, as used herein, refers to a computer-driven application operatively associated with the CPU 50. The program to track shopping habits of a customer 54 may track behaviors including, but not limited to, purchases, returns, browsing history, shopping frequency, or combinations thereof.

A terminal 110, as used herein, refers to an electronic device operatively associated with the CPU used to input and receive data. The terminal 110 is operatively associated with a greeter 20 or clerk 120. For example, a terminal 110 may be used to input data into a database or CPU and receive data from the database or CPU. The terminal 110 may send and receive data from the database by any method including, but is limited to, mechanically, by-wire, wirelessly, or combinations thereof. In one embodiment, the terminal 110 may be comprised of an input terminal 114 and/or an output terminal 118. An input terminal may be selected from the group comprising: a keyboard, a mouse, a joystick, a touchpad, a touchscreen, a light pen, a stylus, or combinations thereof. In one embodiment, a greeter 20/clerk 120 may use an input terminal to select a customer 130 to image with a camera 40 in a retail outlet. The output terminal may be selected from the group comprising: a cathode ray tube, a projector, electronic paper, light-emitting diode, liquid crystal display, plasma display panel, electroluminescent display, organic light emitting diode, surface-conduction electron-emitter display, laser TV, carbon nanotubes, nanocrystal display, a headset, a portable data terminal, or combinations thereof.

The invention also discloses a biometric face recognition process to be used by a greeter which is comprised of a series of steps. The steps include providing a customer recognition system (CRS) 30, imaging a customer 130 with the CRS 30, determining the customer's identity using the customer image and CRS 30, sending a message from the CRS 30 to the greeter 20 containing the customer's identity and the customer's information when a positive identification is made. The greeter 20 may then greet the customer with a personal greeting.

The biometric face recognition process may further comprise additional steps. The steps include providing a credit/debit card reader 60 operatively associated with the CRS 30. Obtaining information about the customer 130 from the credit/debit card reader 60, followed by associating the customer's image with the information obtained from the credit/debit card reader 60. The customer's image and information obtained by the credit/debit card reader 60 is then stored in the CRS 30.

The invention also discloses an additional biometric face recognition process to be used by a greeter which is comprised of a series of steps. The steps include imaging a customer 130 as said customer enters a retail outlet using one or more of the plurality of cameras 40 from the CRS 30. The image is sent to the CPU 50 where it is compared to previously obtained images (e.g., database images, first images) by the biometric face recognition program 70. If a match is found, the CPU 50 sends a message to the greeter 20 containing the customer's identity and information. The greeter 20 may then greet customer 130 with a personalized greeting. In one embodiment, the greeter 20 is provided with a terminal 110 having an input terminal 114 and an output terminal 118. In another embodiment, the customer 130 may be imaged anywhere within the retail outlet. In yet another embodiment, the customer 130 may be imaged outside of the retail outlet.

The biometric face recognition process may further comprise additional steps. The steps include providing a CPU 50, a camera or a plurality of cameras 40 including a camera at a checkout counter 44, a database 52, a credit/debit card reader 60, and a biometric face recognition program 70. The next step is to image a customer 130 at the checkout counter with the camera at the checkout counter 44 to obtain a first image. The next step is to associate information obtained by the credit/debit card reader 60 to the first image. Then both the information and the image are stored in the database 52. In one embodiment, a database 52 may be compiled and/or augmented over time by imaging customers 130 when a purchase is made and associating information obtained from the credit/debit card reader 60 and storing the customer image and customer information on the database 52.

The biometric face recognition process may further comprise additional steps. The additional steps include providing a program to recognize known undesirables 80. Customers 130 have their image taken as they enter the retail outlet or while inside the retail outlet by one or more of the plurality of cameras 40 from the CRS 30. The images of the customers are sent to the CPU 50 where the biometric face recognition program 70 then compares the new images to identify known undesirables by accessing the program to recognize known undesirables 80. Security may be notified when one or more known undesirables are identified. In one embodiment, the images may be stored in the database 52 or deleted.

The biometric face recognition process may further comprise additional steps. The additional steps include providing a terminal 110 which is operatively associated with the clerk 120 and the CPU 50. A customer's image is taken as the customer 130 walks up to a clerk 120 by one or more of the plurality of cameras 40 from the CRS 30. The image is sent to the CPU 50 wherein it is compared to previously obtained images (e.g., database images, first images) by the biometric face recognition program 70. If a match is found, the CPU 50 sends a message to the clerk 120 via the output terminal 118. The clerk 120 can then greet the customer 130 with a personalized greeting. In one embodiment, the image(s) may be stored in the database 52 or deleted. In another embodiment, the image(s) may be associated with known images and stored in the database 52.

The biometric face recognition process may further comprise additional steps including speaking with the customer 130 and imputing additional data obtained from that conversation about the customer 130 into the database 52 by the greeter 20 or the clerk 120. In one embodiment, the additional data may be entered into the database using an input terminal 114.

The biometric face recognition process may further comprise additional steps. The additional steps include providing a program to recognize images of individuals authorized to use a credit/debit card 75 which is operatively associated with said CPU 50 and said biometric face recognition program. A customer's image is taken as the customer 130 makes a purchase using a credit card. The image is sent to the CPU 50 where the biometric face recognition program 70 compares the image to images of individuals authorized to use a credit/debit card and by accessing the program for recognizing images of individuals authorized to use a debit/credit card 75. Then security can be alerted if person using credit/debit card does not match an existing image.

This system can also use additional cameras that are set up at the check out point and when a customer 130 pays by a credit card the store can take a high quality image of the customer 130 and match that image with the information provided by that customer's credit or debit card. This is then stored in the database 52. When the same customer revisits the store, one or more of the plurality of cameras 40 may image the customer 130, the image is sent to the CPU 50 and compared to existing images by the biometric face recognition program 70, and if a match is found, prompt the greeter 20 to greet the customer 130 by name. Other information can be entered into the store's database 52 by clerks 120 using a terminal 110. For example, if a clerk chats with a customer and finds out the customer's child is graduating from school this information can be imputed into the database 52 and the cashier can use the information when the customer 130 checks out so that the customer's visit to the establishment is more personalized, such as “congratulations” about their child graduating.

The present invention may be embodied in other forms without departing from the spirit and the essential attributes thereof, and, accordingly, reference should be made to the appended claims, rather than to the forgoing specification, as indicated in the scope of the invention.

What is claimed is:

1. A system for welcoming a customer to a retail outlet to be used by a greeter comprising:
a customer recognition system (CRS);
said CRS being operatively associated with said greeter;
whereby when a customer is recognized by said CRS, said CRS sends a message to said greeter comprising information about said customer;
whereby said greeter welcomes said customer with a personalized greeting.

2. The system for welcoming a customer according to claim 1 wherein said CRS is comprised of:
a central processing unit (CPU);
a database is operatively associated with said CPU;
a camera is operatively associated with said CPU;
a biometric face recognition program is operatively associated with said CPU;
where said camera is set up to take an image and the image is compared by the biometric face recognition program with images of known individuals.

3. The system of claim 2 wherein said database contains images of known individuals obtained from the group comprising: local government offices, state government offices, national government offices, foreign government offices, affiliated businesses, non-affiliated businesses, in-store cameras, out-of-store cameras, or combinations thereof.

4. The system of claim 2 further comprising:
a credit/debit card reader is operatively associated with said CPU and said camera;
where said camera is set up to take an image of said customer and associate said image with information obtained by said credit/debit card reader to store in said database.

5. The system of claim 4 wherein said camera is at a checkout counter.

6. The system of claim 2 further comprising a plurality of cameras operatively associated with said CPU.

7. The system of claim 2 further comprising a program to recognize known undesirables operatively associated with said CPU and said biometric face recognition program.

8. The system of claim 2 further comprising a program to recognize images of individuals authorized to use a credit/debit card which is operatively associated with said CPU and said biometric face recognition program.

9. The system of claim 2 wherein said database contains images of known individuals or known undesirables obtained from the group comprising: local government offices, state government offices, national government offices, foreign government offices, affiliated businesses, non-affiliated businesses, in-store cameras, out-of-store cameras, or combinations thereof.

10. The system for welcoming a customer according to claim 1 further comprising a terminal operatively associated with said CPU;
wherein said greeter may enter additional information about said customer to store on said database.

11. The system for welcoming a customer according to claim 10 wherein said terminal is comprised of an input terminal and an output terminal.

12. The system of claim 2 wherein said camera further comprising either cross hairs or a laser pointer to select the image wanted.

13. The system of claim 2 further comprising a program to track the shopping habits of a customer operatively associated with said CPU.

14. A method of welcoming a customer to a retail outlet to be used by a greeter comprising the steps of:
providing a customer recognition system (CRS);
said CRS being operatively associated with said greeter;
imaging said customer with said CRS;
determining said customer's identity using said customer image and said CRS;
sending a message from said CRS to said greeter containing said customer identity and customer information when a positive identification is made;
greeting said customer with a personal greeting.

15. The method according to claim 14 further comprising the steps of:
providing a credit/debit card reader operatively associated with said CRS;
obtaining information about said customer from said credit/debit card reader;
associating said customer image with said information obtained from said credit/debit card reader;
storing said customer image and said information obtained by said credit/debit card reader in said CRS.

16. A method of welcoming a customer to a retail outlet to be used by a greeter comprising the steps of:
providing a customer recognition system (CRS);
said CRS being operatively associated with said greeter;
imaging said customer with a camera;
determining said customer's identity using a biometric face recognition program by comparing a customer's image with images in a database;
sending a message from said database to said greeter containing said customer identity and customer information when a positive identification is made;
greeting said customer with a personal greeting.

17. The method according to claim 16 further comprising the steps of:
providing a program to recognize known undesirables operatively associated with said CPU and said biometric face recognition program;
imaging said customer with said camera;
identifying known undesirables using said program to recognize known undesirables and said biometric face recognition program;
notifying security at said retail outlet when one or more known undesirables are identified.

18. The method according to claim 16 further comprising the step of:
providing a terminal operatively associated with said greeter and said CPU;
adding additional information about said customer to said CRS.

19. The method according to claim 18 further comprising the steps of:
talking to said customer; and
imputing additional data about said customer into said database by said clerk through said terminal.

20. The method of claim 16 further comprising the step of:
providing a camera with either cross hairs or a laser pointer to pinpoint the image wanted;
selecting a customer to image with said CRS.
